(19) United States
(12) Patent Application Publication
(10) Pub. No.: US 2005/0102160 A1
(43) Pub. Date: May 12, 2005

(54) Method for improving the efficiency of doctor-patient interactions and software for same

(75) Inventor: Jay Edward Brown, Ames, IA (US)

Correspondence Address: JONATHAN D. FEUCHTWANG, 150 NORTH WACKER DRIVE, SUITE 1200, CHICAGO, IL, 60606, US

(73) Assignee: LCDmd, Inc.

(21) Appl. No.: 10/705,145

(22) Filed: Nov. 10, 2003

(51) Int. Cl. G06F 17/60

(52) U.S. Cl. 705/2

(57) ABSTRACT

Disclosed is a method for increasing the efficiency of doctor-patient interactions using patient education software. The method includes the step of gathering medical history information from a patient; reviewing the medical history; assembling and presenting a first audio visual presentation to the patient using the patient education software; examining the patient; and diagnosing patient's medical condition and discussing treatment options with patient. The patient education software facilitates the compilation of a full-motion audio-visual presentation customized to the specific medical condition of each patient and facilitates the production of review materials for the patient.

### FIELD OF THE INVENTION

The present invention relates to a method for improving the effectiveness and efficiency of doctor-patient interactions via patient education software used to explain the diagnosis and treatment regimen prescribed by a treating clinician.

### BACKGROUND

The successful treatment of patients requires a sequence of three processes: collecting the needed information to arrive at the correct diagnosis, choosing the proper treatment plan, and successfully enlisting the patient or care giver to fulfill their role in the implementation of that plan. This last step is critical; patients ineffectively educated regarding their treatment plan are at increased risk of under- and over-dosing medications, of unsuitable combinations of medicines, of making less informed decisions, and of treatment noncompliance.

Drugs are ineffective if not taken. One of medicine's greatest challenges is getting patients to follow good medical advice. The magnitude of that challenge is reflected in a study done by Bender et al who reported that when inhaled steroid medication compliance has been monitored by an electronic device attached to the inhaler, compliance was a mere 50%. Why would someone go to the trouble of seeking expert advice, and then not follow it? No doubt there are scores of reasons. Some patients cannot afford the treatments. Some are forgetful, some are distrustful, and some don't even speak English. To a large extent, the responsibility for this failure lies with the health care provider. How many patients leave the office not fully comprehending why, how and when to use medications or other treatments, or not fully aware of potential side effects? Legorreta et al surveyed 5580 asthmatic patients covered under an HMO, and reported that:

The National Asthma Education Program guidelines specify that physicians or nurses should provide asthmatic patients with information about (1) what to do for a severe episode of asthma, (2) how to adjust medications when asthma worsens, and (3) how to avoid triggers of asthma. Approximately 42% of the respondents reported that they were provided with these self-management tools.

The primary modality for patient education has the physician teaching the patient directly. Health care providers do engender authority, and although medical care will always require a human touch, this “one on one” communication leaves much to be desired. The chief shortcoming may be that it is profoundly time consuming. Investigators at Duke University published in the American Journal of Public Health estimated that if an average family practice doctor seeing 2500 patients per year were to adhere to the recommendations of the US Preventive Services Task Force, she or he would spend 7.4 hours each day exclusively on preventative services. Over 80% of those 7.4 hours was spent on pure counseling services. Unfortunately, a busy clinician does not have time to perform those services. A survey of young physicians in 1991 found that 84% of respondents felt they had adequate time to spend with patients. A follow up survey in 1997 found that only 32% felt they could spend sufficient time with patients.

The amount of time doctors spend with patients is decreasing as physicians increase their workloads to maintain their salaries. Relative value units (RVU's), a measure of physician throughput, increased for allergists from 7,855 per doctor per year in 1997 to 10,473 in 2001 while salaries remained nearly unchanged.

Some are predicting a shortage of medical specialists that would further compound the time pressures facing clinicians charged with persuading patients to follow advice. The supply of new medical specialists is worsened by cutbacks at many of the public and private medical centers where medical specialists are trained. Dickler and Shaw wrote in 2000, before the latest economic downturn made matters ever worse, that “The disproportionate effects of this legislation [the balanced budget act of 1997] on teaching hospitals and their physicians have the potential to undercut the ability to operate and fund missions associated with education . . . ” For example, the number of training positions in the field of allergy/immunology has shrunk from 305 in 1993 to 205 in 2003. During that same interval, the number of training programs decreased from 93 to 70, some from consolidation and some from closures. Any future surge in physician retirements caused by slippage in the quality of life of doctors will have a predictable negative impact on direct physician-to-patient education, as the pool of specialists gets shallower. The existing malpractice crisis experienced in several states has already impacted the availability of numerous specialists in areas with particularly high malpractice premiums. Moreover, as the supply of specialists shrinks, the demand is expected to grow as the population ages.

At the same time there are fewer doctors available to explain the treatment plans, the amount of information that needs to be presented is ever increasing. A bounty of clinical practice guidelines and an ever expanding list of available medications place evolving demands on doctors with respect to their duty of informing patients.

Time constraints are not the only problem. Language barriers can also impede communication. Data from the 2000 census indicates that the percentage of the US population that speaks a language other than English at home is 17.9%. The adverse effects of a language barrier on a patient's access to care, quality of care, compliance with care, and satisfaction with care are well documented.

The vast majority of face-to-face patient education is extemporaneous, and therefore un-standardized. Extemporaneous education opens up the possibility of omissions, and makes documentation of all the details provided to a patient nearly impossible, resulting in greater medical-legal exposure for health care providers and their institutions. Even if the doctor does flawlessly explains all important details of a given patient's diagnosis and treatment, the patient, often times distracted by illness or made nervous by the office or hospital environment, doesn't absorb the information and has no simple way to review the information as presented by the doctor.

Another pervasive compliance issue relates not to patients' compliance, but to provider compliance with expert panel driven guidelines. In the study by Legorret, well under half of surveyed patients were receiving the information deemed important by NAEP guidelines.

A factor not addressed in the medical literature also affects the transfer of information from providers to patients: the intellectual stimulation of repeating instructions on the use of nose sprays, dust mite avoidance measures, inhaler technique etc. over and over again wears off. The monotony of the repetition can result in both a less than enthusiastic set of instructions and a less gratifying job experience for the practitioner.

Efforts to augment face-to-face explanations leave much to be desired. Pamphlets have been a staple for decades, but require that the information presented be well suited to the patient and that the patient be both literate and motivated. Videotapes are available on a whole range of subjects, but typically are vague, expensive and lengthy when shown in their entirety. The information on videotape is stored in a linear fashion and offers no simple way to tailor an educational program that is both complete yet without extraneous information. They also become dated and get damaged and misplaced. Nurses and pharmacists often reinforce patient education, and although they are critical members of the health care team, their efforts are often stymied by the same problems facing physicians: time constraints, lack of standardization, language barriers, and inability to precisely document exactly what the patient was told.

We have the world's most costly health care system composed of well-trained and committed medical personnel. However, there is ample room for improvement in the health care system's capacity to convey the causes of illnesses and their treatment. While making the correct diagnosis and selecting a correct treatment plan is critical to good care, an inability to enlist the patient's cooperation in the implementation of a treatment plan nullifies some or all of the gains to be made by therapy.

Two of the central tenants of quality enhancement programs taught in business schools and applied in industry over the past 40 plus years are that 1) high quality requires low variability and 2) methods of assessing the effectiveness of a process are required before best practices can be broadly agreed upon and adopted. In the manufacturing sector, tighter tolerances, a classic case of reduced variability, yield obvious enhancements in quality. For example, an engine part made to within 1 micrometer of design specifications will perform better than one made within 3 micrometers. On the surface, however, the axiom is challenging to apply in the practice of medicine. The uniqueness of each person coupled with the variable manifestations of disease renders any blanket approach to a given illness impractical. However, within each treatment plan, there exist indivisible boluses of information that could be applied to large groups of patients.

For example, the avoidance of allergens is too broad a subject for a large population of patients with allergic rhinitis or asthma, as allergic sensitivities vary from one patient to the next. A blanket overview on a video cassette explaining mold, dust, animal dander and pollen avoidance is not practical for a patient just allergic to dust mites. In addition to wasting the patient's time with unneeded information and jamming up an examining room as the patient views extraneous information, the superfluous information may confuse the patient, resulting in unnecessary efforts and expenditures on their part. Yet the narrower subject of dust mite avoidance will not vary much from one dust mite allergic patient to the next.

Likewise, a broad overview of the treatment of asthma with vague references to anti-inflammatory medication and bronchodilators is not nearly as useful as a specific discussion of the actual medicines being prescribed. It is far more desirable to have a patient learn about those subjects in the context of the drugs they will be using, including a discussion of the specific techniques required for use, the rational for use, side effects, and drug—drug interactions. For a given medicine, the information required for a complete discussion without unneeded information will be relatively constant from one patient to the next.

Accordingly, what is needed is a system or method for increasing the efficiency of interactions between physicians and patients by reducing the amount of time necessary to present routine information, thereby enabling the medical service provider to focus on answering the patient's questions and/or addressing the patient's concerns.

### BRIEF DESCRIPTION OF THE DRAWINGS

FIG. 1 is a flow diagram of a first embodiment of the method for improving the efficiency of doctor-patient interactions;

FIG. 2A is a block diagram of the patient education software of the present invention; and

FIG. 2B is a block diagram of a full-motion audio-visual clip according to the present invention.

### DETAILED DESCRIPTION OF THE INVENTION

Disclosed herein is a method for presenting medical information to a patient. The goal of the present invention is to maximize the effectiveness and efficiency of doctor-patient interactions using patient education software to present full-motion video information regarding the prevention of illness as well as the diagnosis and treatment of illness that is tailored to fit the specific needs of a given patient.

Taking advantage of the non-linear data retrieval of a computer's hard drive, full motion video clips can be accessed from a large list of titles and played for the patient in the examining room. From a list of over 70 available subjects, each lasting 30 to 300 seconds, the clinician selects only those that are felt applicable to given patient. The presentation is composed of one or more distinct audio-visual clips which are stored on a random access device such as a Winchester drive, CRROM, DVD or the like.

The method of the present invention reduces the amount of time necessary to present routine information and enables the medical service provider to focus on answering the patient's questions and/or addressing the patient's concerns. The goal of the present invention is to allow healthcare professionals like doctors, physician assistants, nurse practitioners, nurses or pharmacists a means to provide a patient with concise and comprehensive information regarding the diagnosis and treatment of their specific medical problems.

The method of the present invention includes the use of patient education software that reduces the amount of time needed for the doctor to explain routine aspects of the diagnosis and treatment options. The patient education software enables the treating physician to quickly assemble a presentation of education materials tailored to the individual medical conditions of each patient by selecting individual video clips from among a library of pre-recorded video clips.

The patient education software is highly modular, and may be readily be updated to reflect, among other things, changes in diagnosis and treatment.

A particular patient can be shown a whole presentation chosen by their doctor of just those subjects that fit that patient's needs. For example, a presentation might consist of the following videos: “Symptoms of Asthma”, “Complications of Asthma”, “Asthma Action Plans”, “Dust Mite Avoidance”, “Pulmicort Turbuhaler”, “Maxair” and “Heartburn and Asthma”. For this example, the total running time of the whole presentation would be 12 minutes 45 seconds. The clips feature full motion videos all with banner headlines and lots of on-screen text to reinforce teaching points. Many have animations. All are intended to be comprehensible at the 5^{th} grade level. The patient education software enables the user to control the pace of the presentation, and repeat information as needed. After the patient watches the clips, the provider returns to answer questions and reinforce critical points.

The main interface provides a listing of available clips available for selection. A customized presentation is assembled for a patient by, for example, checking a box to the left of the title of a given clip in the library. The interface allows the provider a chance to review the features of individual clips in the library by highlighting the clip title, which then shows the running time of the individual clips and a written summary of their content in a box labeled “Preview”. By selecting a preview button, the provider may view the actual clip in a small preview box. As clips are selected for the patient, a listing of the selected clips is indicated along with a total running time of all clips selected.

The patient education software facilitates the construction of multi-lingual presentations. Importantly, the language used by the provider in constructing the presentation is completely independent of the language of the presentation. For example, a non-Spanish speaking user may construct a Spanish language presentation simply by selecting the appropriate clips and selecting the “Spanish” button.

Typical utilization of the system has a provider selecting clips for a patient after a diagnosis and treatment plan have been determined. After the patient watches the clips, the provider returns to answer questions and reinforce critical points. Some of the clips may be shown to a patient even before the doctor has seen the patient, for example a nurse, as she put the patient in an examination room, might have the patient review information about an existing treatment plan. Another scenario has a patient viewing clips in the middle of a visit; a patient might be shown a clip on a diagnostic test before it is performed.

Because learning so often requires repetition, the system and method of the present invention makes it easy for the patient to review the information selected by the provider at his/her own pace. The system of the present invention allows the patient to stop and review the customized presentation in the middle of the presentation, and review some or all of the clips after the entire selection of clips chosen by the provider has been watched once by the patient.

At the doctor's discretion, printed material corresponding to the selected clips can be generated while the patient watches the clips. Instead of—or in addition to—giving a patient printed reading material, the doctor can offer a CD-ROM with all the clips chosen by the doctor. The CD-ROM can be burned while the patient watches the clips, so this offering does not impede the flow through the office. According to U.S. Census Bureau data, as of September 2000, 51% of homes in the United States have computers¹⁷, and almost all of those computers would allow for the viewing of such a CD, as the CD can be played back using Windows software dating to the Windows 95 operating system or on a Macintosh computer. For those who do not have computers, most public libraries now offer computer access, so that anyone with a library card can review some or all of the videos for free, and the librarian would likely help computer novices.

Optionally, the system may include one or more educational games which reinforce the concepts presented in the customized presentation. At the completion of the presentation, the option of reviewing some or all of the clips is offered to the patient along with the option of playing some games. While most of the games offered are simply links to games included in the operating system, one of them was developed to reinforce some of the messages in the educational video clips. The inventors of the present invention have developed a game called “Asthma Trigger Happy,” with a main character protecting an airway from inflammation caused by a cascade of asthma triggers, like animal danders, dust mites, pollen, and cigarette smoke by firing inhalers, nose sprays, and peak flow meters at the cascade of the falling asthma triggers. As the “triggers” land on the doctor, a normal bronchiole cross-section in the lower left of the screen becomes increasingly inflamed.

By selecting the “Print Label” button, the system can print a sticker or the like with a listing of all materials selected for the patient to be placed in the patients chart, allowing for full documentation of materials shown to the patient thereby reducing medical-legal exposure. The system can be integrated into an existing electronic medical record so that the virtual record will reflect what clips the patient was shown.

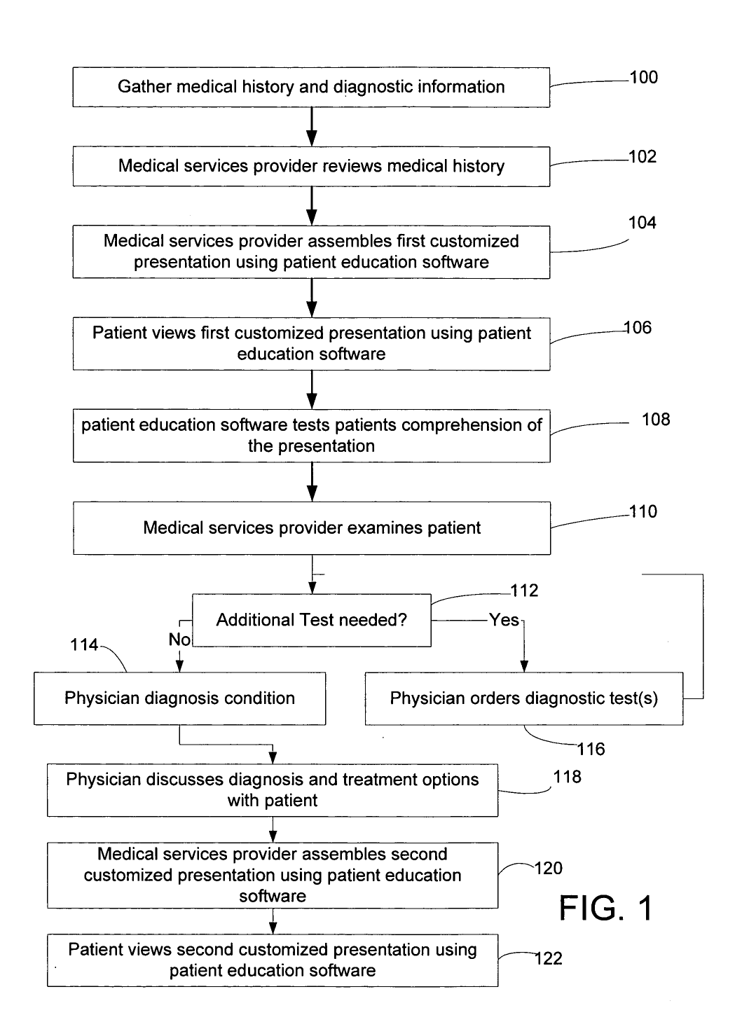

FIG. 1 is a flow chart of a first embodiment of the present invention.

A medical service provider such as a physician, nurse, or medical technician meets with the client and gathers diagnostic information including medical history and the like (step 100) using conventional screening questions. The specific questions and diagnostic tests will vary depending on the medical condition(s) being diagnosed, and are beyond the scope of the present invention.

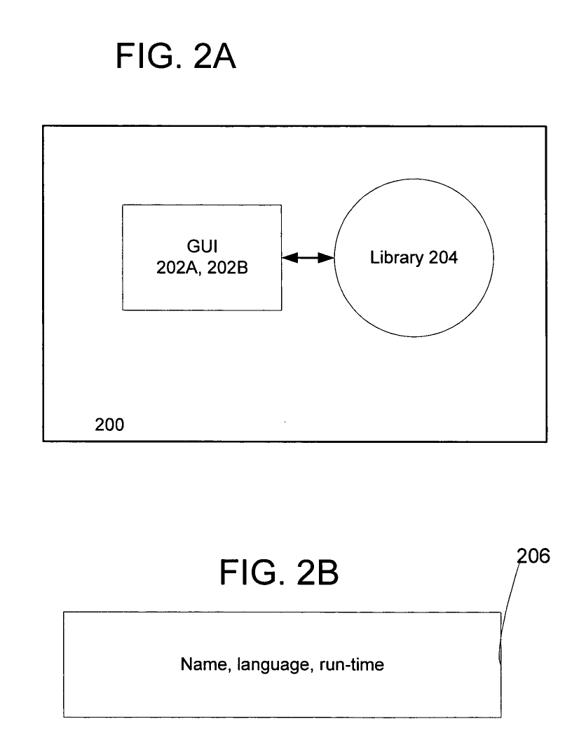

The medical service provider reviews the patient's medical history (step 102), and optionally assembles a first customized presentation of diagnostic and treatment information (step 104). The customized presentation is constructed using patient education software 200 of the present invention (FIG. 2). The physician may personally utilize the patient education software to assemble the presentation, or will delegate such responsibility to a third-party such as a nurse or the like.

The patient views the presentation (step 106) using the patient education software 200, preferably before meeting with the medical service provider. The patient education software 200 enables the user to control the pace of the presentation, and repeat information as needed. Optionally, the patient may print a printed copy or a CD ROM of desired information.

The software 200 may optionally test the patient's comprehension of the information provided in the presentation (step 108). This aspect of the invention provides feedback and may alert the physician of particular topics which should be reviewed with the client.

Optionally, the software may track how many times the patient viewed each clip. This aspect of the invention provides feedback and may alert the physician of particular topics which should be reviewed with the client. Additionally, the need to revise a particular clip may be indicated if many patients repeat a particular clip multiple times.

The patient is examined by the medical service provider (steps 110 and 112) and either diagnoses the patient's condition (step 114) or prescribes diagnostic tests (step 116). The medical service provider discusses either the patient's diagnosis and treatment options or the need for additional tests (step 118), assembles an optional second audio-visual presentation customized for at least one of the patient's diagnosis, treatment plan, and prescribed testing (step 120).

The patient views the second audio-visual presentation (step 122)

It should be appreciated that the methodology of the presentation is flexible and may be used in several slightly different variations. Notably, the medical service provider may opt to use only the first presentation (step 104), only the second presentation (step 118), or both presentations. The flowchart depicted in FIG. 1 assumes that the patient is provided with both presentations; either the first or second presentations may be omitted if desired.

If diagnostic tests were prescribed (in step 116), the medical service provider may diagnose the patient's condition after viewing the results of the additional tests (steps 112, 114), or will prescribe an additional series of diagnostic tests (step 112, 116).

FIG. 2A is a block diagram of the patient education software 200 of the present invention.

The software 200 includes an interface 202 such as a graphical user interface used to assemble and view audio-video presentations, and a library 204 containing a plurality of audio-video clips 206. The library 204 may contain plural language-specific versions of the audio-video clips 206.

The software 200 of the present invention is not limited to any specific data format or operating system.

As illustrated, the patient education software 200 includes a service provider interface 202a and a patient interface 202b. The service provider interface 202a provides access to all of the features of the patient education software 200 and is used to assemble the customized presentation and perform various other maintenance functions (e.g., add change or delete video clips). The patient interface 202b is used to view the customized presentation, and enables the patient to control the pace at which information is presented.

The patient education software 200 facilitates the construction of multi-lingual presentations. Importantly, the language used by the user in constructing the presentation is completely independent of the language of the presentation. For example, a Spanish language presentation may be constructed by a non-Spanish speaking user.

FIG. 2B is a sample data structure diagram for the full-motion audio-video clip 206. As shown, the clip includes a title, information specifying the run-time of the clip, and language (English, Spanish etc.).

A patient education presentation is assembled by selecting one or more clips 206 from the library 204. For example, clips 206 may be selected using a pointing device such as a mouse or the like.

The service provider interface 202a enables the medical service provider to view information regarding individual clips 206 by, for example, selecting (a clip using a pointing device such as a mouse or the like.

According to a preferred embodiment, the additional information may include a brief description and running time of the clip 206. Additionally, the service provider interface 202a may enable a user to preview clips 206 by, for example, selecting a preview button (not illustrated).

As clips 206 are selected, a listing of the selected clips is displayed, along with a total running time of the clips selected.

The method of the present invention enables the patient to control the pace at which information is presented. Notably, the patient can pause and review information as many times as needed, enabling the patient to learn at his/her individual pace.

According to one aspect of the invention, the software 200 may be used to document the materials viewed by the client. For example, the software 200 may print a listing of all the video clips viewed by the patient. The listing may be added to the patient's medical records. Alternatively, the software 200 may simply transfer an electronic record of the clips viewed by the patient to the physician's electronic charting software via a network connection such as is known in the art.

The patient education software is highly modular. Notably individual clips 206 may be added, changed, or deleted on-the-fly without the need to modify the software.

While there have been described herein what are considered to be preferred and exemplary embodiments of the present invention, other modifications of the invention shall be apparent to those skilled in the art from the teachings herein, and such modification fall within the scope and spirit of the present invention.

1. A method for increasing the efficiency of doctor-patient interactions using patient education software, comprising the steps of:
gathering medical history information from a patient;
reviewing said medical history;
assembling and presenting a first audio visual presentation to the patient using patient education software; and
examining patient;
diagnosing patient's medical condition and discussing treatment options with patient.

2. The method according to claim 1, further comprising a step of assembling and presenting a second audio visual presentation to patient using said patient education software after said step of diagnosing patient's medical condition.

3. The method according to claim 1, further comprising a step of conducting diagnostic tests prior to said step of diagnosing patient's medical condition.

4. A method for increasing the efficiency of doctor-patient interactions comprising the steps of:
gathering medical history information from a patient;
reviewing said medical history;
examining the patient;
diagnosing the patient's medical condition and discussing treatment options with the patient; and
assembling and presenting a second audio visual presentation to the patient using patient education software.

5. The method according to claim 4, further comprising a step of conducting diagnostic tests prior to said step of diagnosing the patient's medical condition.

6. Patient education software, comprising:
a library storing a plurality of full-motion audio visual clips;
a service provider interface for assembling an audio-visual presentation by selecting at least one of said full-motion audio visual clips; and
a patient interface for viewing said audio-visual presentation, said patient interface providing the patient with the ability to stop or pause said audio-visual presentation at any given point and review one or more of said full-motion audio visual clips included in said audio-visual presentation.

7. The patient education software according to claim 6, further comprising means for transferring an electronic record of full-motion audio visual clips included in said audio-visual presentation to electronic charting software.

8. The patient education software according to claim 6, further comprising means for printing a list of full-motion audio visual clips included in said audio-visual presentation.

9. The patient education software according to claim 6, wherein a language of the full-motion video clip is different from a language of the service provider interface used to assemble the audio-visual presentation.
